(19) United States
(12) Patent Application Publication
(10) Pub. No.: US 2025/0159606 A1
(43) Pub. Date: May 15, 2025

(54) INTER-DRX ASSISTANCE METHOD FOR OPERATING A USER EQUIPMENT (UE)

(71) Applicant: Continental Automotive Technologies GmbH, Hannover (DE)

(72) Inventors: David Gonzalez Gonzalez, Egelsbach (DE); Abdelkarim Belhoula, Asslar (DE); Claus Chrometz, Butzbach (DE); Andreas Andrae, Frankfurt am Main (DE); Osvaldo Gonsa, Frankfurt (DE); Rikin Shah, Langen (DE)

(73) Assignee: Continental Automotive Technologies GmbH, Hannover (DE)

(21) Appl. No.: 18/839,481

(22) PCT Filed: Feb. 20, 2023
(86) PCT No.: PCT/EP2023/054182

§ 371 Date: Aug. 19, 2024

(30) Foreign Application Priority Data
Feb. 18, 2022 (DE) 10 2022 201 716.1

(51) Int. Cl. H04W 52/02; H04W 72/25; H04W 76/28

(52) U.S. Cl. CPC H04W 52/0229; H04W 72/25; H04W 76/28

(57) ABSTRACT

An inter-DRX Assistance method for operating a user equipment (UE) and network device, of a wireless communication system in a Discontinuous Reception (DRX) mode, the wireless communication system including a plurality of user equipments (UE), and the UE communicating with one or more further user equipments (UEs) by receiving, by the user equipments (UE), at least one Discontinuous Reception (DRX) configuration from one of a plurality of a Discontinuous Reception (DRX) configuration sources, whereby that plurality of Discontinuous Reception (DRX) configurations is configured for the same Media Access Control (MAC) entity in order to reduce the power consumption of the user equipment.

### CROSS-REFERENCE TO RELATED APPLICATIONS

The present application is a National Stage Application under 35 U.S.C. § 371 of International Patent Application No. PCT/EP2023/054182 filed on Feb. 20, 2023, and claims priority from German Patent Application No. 10 2022 201 716.1 filed on Feb. 18, 2022, in the German Patent and Trademark Office, the disclosures of which are herein incorporated by reference in their entireties.

### TECHNICAL FIELD

The embodiments of the present application relate to the field of communications, and more specifically, to a method and device for Discontinuous Reception (DRX).

### BACKGROUND

In consideration of power saving of a terminal device, DRX mechanism is introduced. The network device can configure the terminal device to “wake up” at the time predicted by the network device and monitor the downlink control channel when it wakes up, or configure the terminal device to “sleep” at the time predicted by the network device and does not monitor the downlink control channel during the sleep. In this way, if the network device has data to be transmitted to the terminal device, the terminal device can be scheduled during the wake-up time of the terminal device, and the terminal device can reduce power consumption during the sleep time.

Bandwidth Part (BWP) is introduced in new radio (NR). The terminal device can support multiple BWPs, and can switch between the supported BWPs. In order to satisfy different types of services scheduled on different BWPs, the network device can configure different Control Recourse Sets (CORESETs) and Search Spaces on different BWPs.

### BRIEF SUMMARY

The embodiments of the present application provide a method and device for discontinuous reception.

In a first aspect, an inter-DRX Assistance method for operating a user equipments (UE) and an access point, like a base station, gNB, or gateway node, of a wireless communication system in a Discontinuous Reception (DRX) mode, the wireless communication system including a plurality of user equipments (UE), and the UE communicating with one or more further user devices (UEs) using the method comprising:

receiving, by the user equipment (UE), a least one Discontinuous Reception (DRX) configuration from one of a plurality of a Discontinuous Reception (DRX) configuration sources, wherein that plurality of Discontinuous Reception (DRX) configurations is configured for the same Medium Access Control (MAC) entity in order to reduce the power consumption of the user equipment.

In a second aspect, an inter-DRX Assistance method for operating a user equipment is provided, including: sending by a network device a plurality of DRX configurations to a terminal device, where the plurality of DRX configurations is used for the terminal device to determine at least one DRX configuration for detecting a physical downlink control channel (PDCCH).

In a third aspect, a terminal device is provided, which can perform the method in the foregoing first aspect or any optional implementation of the first aspect. Specifically, the terminal device can include a functional module for performing the method in the foregoing first aspect or any possible implementation of the first aspect.

In a fourth aspect, a network device is provided, which can perform the method in the foregoing second aspect or any optional implementation of the second aspect. Specifically, the network device can include a functional module for performing the method in the foregoing second aspect or any possible implementation of the second aspect.

In a fifth aspect, there is provided a terminal device including a processor and a memory. The memory is used for storing a computer program, and the processor is configured to call and run the computer program stored in the memory to perform the method in the above-mentioned first aspect or any possible implementation of the first aspect.

In a sixth aspect, there is provided a network device including a processor and a memory. The memory is used for storing a computer program, and the processor is configured to call and run the computer program stored in the memory to perform the method in the above-mentioned second aspect or any possible implementation of the second aspect.

In a seventh aspect, a chip is provided to implement the method in the foregoing first aspect or any possible implementation of the first aspect. Specifically, the chip includes a processor configured to call and run a computer program from a memory to cause the device installed with the chip to perform the method in the first aspect or any possible implementation of the first aspect.

In an eighth aspect, a chip is provided to implement the method in the foregoing second aspect or any possible implementation of the second aspect. Specifically, the chip includes a processor configured to call and run a computer program from a memory to cause the device installed with the chip to perform the method in the second aspect or any possible implementation of the second aspect.

In a ninth aspect, a computer-readable storage medium is provided for storing a computer program that causes a computer to perform the method in the above-mentioned first aspect or any possible implementation of the first aspect.

In a tenth aspect, a computer-readable storage medium is provided for storing a computer program that causes a computer to perform the method in the above-mentioned second aspect or any possible implementation of the second aspect.

In an eleventh aspect, a computer program product is provided, including computer program instructions that cause a computer to perform the method in the foregoing first aspect or any possible implementation of the first aspect.

In a twelfth aspect, a computer program product is provided, including computer program instructions that cause a computer to perform the method in the foregoing second aspect or any possible implementation of the second aspect.

In a thirteenth aspect, a computer program is provided, which when running on a computer, causes the computer to perform the method in the first aspect or any possible implementation of the first aspect.

In a fourteenth aspect, a computer program is provided, which when running on a computer, causes the computer to perform the method in the second aspect or any possible implementation of the second aspect.

In a fifteenth aspect, a communication system is provided, including a user equipment and/or terminal device and a network device.

In another further aspect the inter-DRX Assistance method for operating a user device (UE) of a wireless communication system in a Discontinuous Reception (DRX) mode, the wireless communication system including a plurality of user devices (UE), every user device (UE) having a transmitter (TX) and a receiver (RX), and the user devices (UE) communicating with one or more further user devices (UEs), is characterized by when a first user device (TX UE) intends to transmit data to a second user device (RX UE) via a communication mode PC5 interface to activate component carrier 2 (CC2) whereby due to Discontinuous Reception (DRX) configuration component carrier 2 (CC2) is in sleep mode, an indication is sent through an interface with more than one component carrier (CC), Bandwidth Part (BWP) and corresponding Discontinuous Reception (DRX) cycles to activate component carrier 2 (CC2) at the second user device (RX UE) and when the indication is received by the second user device (RX UE) over component carrier 1 (CC1) data communication over component carrier 1 (CC1) via the communication mode PC5 interface is established.

In another further aspect method is characterized by, wherein an indication is sent over component carrier 1 (CC1) or over an Uu interface.

In another further aspect method is characterized by, wherein indication is stated via SCI@PSSCH or MAC Control Element (MAC CE).

In another further aspect method is characterized by, wherein that a plurality of Discontinuous Reception (DRX) configurations is configured for the same Media Access Control (MAC) in order to reduce the power consumption of the user device.

Wherein the terminal device is configured to: determine a target DRX configuration to be used among a plurality of DRX configurations, the target DRX configuration including one or more DRX configurations; and detect a physical downlink control channel (PDCCH) based on the target DRX configuration and a sidelink control information (SCI) and Physical Sidelink Control Channel (PSCCH). For example, if gNB wants to set carrier 0 activated then it will set and 1 in SCI PSSCH.

Wherein the network terminal device is configured to determine the plurality of DRX configurations, the plurality of DRX configurations being used for the terminal device to determine the target DRX configuration to be used, the target parameter group including one or more DRX configurations, and the target DRX configuration being used for the terminal device to detect the physical downlink control channel (PDCCH); and send DRX configuration information to the terminal device, the DRX configuration information including information of the plurality of DRX configurations.

Wherein the terminal device is configured to perform the method in the first aspect or any possible implementation of the first aspect, and the network device is configured to perform the method in the second aspect or any possible implementation of the second aspect.

U.S. Pat. No. 9,572,062 B2 discloses a methods and apparatus for managing radio measurements during discontinuous reception. In one exemplary embodiment, the distribution of Long Term Evolution (LTE) DRX measurements is staggered or distributed across multiple DRX cycles (which may be contiguous or non-contiguous) so as to reduce the transceiver activity and power consumption. The exemplary UE in one implementation only performs a subset of measurements during each DRX cycle. By staggering or distributing cell measurements over multiple DRX cycles, the UE can improve power consumption, while still conforming to measurement requirements.

U.S. Pat. No. 8,054,758 B2 discloses a method for transitioning between multiple reception levels. There is provided a method for enabling a user equipment (UE) to transition between a non-discontinuous reception (Non-DRX) level and at least one discontinuous reception (DRX) level. The UE in a DRX level wakes up periodically to monitor a scheduling channel. The method includes receiving a DRX indicator in a Non-DRX level with continuously monitoring the scheduling channel and transitioning from the Non-DRX level to a DRX level indicated by the DRX indicator. The UE can transition between multiple DRX levels by an explicit command/signaling.

US2021176814 A1 discloses a discontinuous transmission method and device, capable of improving the discontinuous transmission performance of a terminal device and further reducing the power consumption of the terminal device. The method comprises: the terminal device determines at least one DRX configuration in multiple DRX configurations; and the terminal device detects a physical downlink control channel (PDCCH) according to the at least one DRX configuration.

KR 102313704 B1 a method for discontinuous reception and a device. The method includes: a terminal device determines at least one target discontinuous reception (DRX) indication signal among multiple DRX indication signals and/or a time-frequency resource position occupied by the at least one target DRX indication signal, wherein the at least one target DRX indication signal is used for instructing the terminal device to perform a target behavior in one DRX cycle after receiving the at least one target DRX indication signal; and the terminal device detects a DRX indication signal sent by a network device according to the at least one target DRX indication signal and/or the time-frequency resource position occupied by the at least one target DRX indication signal. The method for discontinuous reception provided by the present application may reduce power consumption of the terminal device.

US2020245395 A1 discloses ENHANCED CONNECTED MODE DRX PROCEDURES FOR NR. Embodiments described herein include DRX operations that address impacts of beamforming to current DRX operations. It is recognized herein that the new NR-PDCCH may affect the downlink control channel monitoring in DRX operations. DRX embodiments described herein also address the impact of new NR-PDCCH to DRX operations. It is further recognized herein that, in NR, multiple DRX configurations may be supported, and L1/2 signaling (such as MAC CE based) can be used for dynamic DRX configuration switching. Embodiments described herein include signaling and other mechanisms that support multiple DRX configurations and switching between multiple configurations. Embodiments described herein also include DRX operations that address the impact of HARQ design in NR to DRX operations. Embodiments described herein further include DRX operations that address the impact of multiple SR configurations in NR to DRX operation.

WO 2021163527 A1 discloses METHODS FOR PERFORMING DISCONTINUOUS RECEPTION ON SIDELINK. A method for determining a DRX operation in a wireless transmit receive unit (WTRU) that has information indicating multiple DRX configurations, includes selecting a first DRX configuration from the multiple DRX configurations based on a first cast type and an associated first quality of service (QOS) information for a first sidelink radio bearer (SLRB) configuration, selecting a second DRX configuration from the multiple DRX configurations based on a second cast type and an associated second Qos information for a second SLRB configuration, determining a sidelink monitoring time based on a combination of an active time associated with the first DRX configuration and an active time associated with the second DRX configuration, and monitoring a sidelink control channel using the determined sidelink monitoring time.

US2011002281 A1 Discontinuous reception (DRX) operations for wireless communications implementing carrier aggregation are disclosed. Physical downlink control channel implementation for carrier aggregation is also disclosed. DRX methods are disclosed including a common DRX protocol that may be applied across all component carriers, an individual/independent DRX protocol that is applied on each component carrier, and hybrid approaches that are applied across affected component carriers. Methods for addressing the effects of loss of synchronization on DRX, impact of scheduling request on DRX, uplink power control during DRX, and DRX operation in measurement gaps are disclosed.

WO 2021163404 A1 Power efficient measurements may be implemented for high frequency operations. A WTRU may determine measurement occasions, DRX cycle/configuration transitions, DRX pause/resume, DRX timer operation, and/or BFR based on scheduling activity, beam configuration, BFI detection, BFD, beam loss, etc. A WTRU may be configured with multiple DRX cycles and measurement opportunities (e.g., with different periodicities). The WTRU may perform (e.g., RS) measurement(s) with determined/configured timing (e.g., DRX on-durations) in a first DRX cycle based on condition(s). The WTRU may switch to a second DRX cycle and perform RS measurement(s) with determined/configured timing based on condition(s) (e.g., counted number of BFIs detected in first DRX cycle). The WTRU may switch from the second (e.g., short) DRX cycle to the first (e.g., long) DRX cycle or to non-DRX operation (e.g., DRX suspension or reset DRX inactivity timer) based on condition(s) (e.g., number of BFIs in first and/or second DRX cycle(s)).

WO 2021160495 A1 titled NR SIDELINK DISCONTINUOUS RECEPTION, a user device, UE, for a wireless communication system is described. The wireless communication system includes a plurality of user devices, UEs. The UE communicates with one or more further UEs using a sidelink, SL. To operate in a Discontinuous Reception, DRX, mode, the UE receives a DRX configuration from one of a plurality of DRX configuration sources. The plurality of DRX configuration sources are ranked such that each of the DRX configuration sources has a rank different from the remaining DRX configuration sources, and the UE is to select the DRX configuration from the DRX configuration source having the highest rank among the available DRX configuration sources.

U.S. Pat. No. 10,165,606 B2-Method and apparatus for enhancing discontinuous reception in wireless systems A method of discontinuous reception (DRX) in a wireless transmit receive unit (WTRU) includes the WTRU receiving DRX setting information over a radio resource control (RRC) signal, and the WTRU receiving DRX activation information over medium access control (MAC) signal.

S. H. A. Shah, S. Aditya and S. Rangan, “Power-Efficient Beam Tracking During Connected Mode DRX in mmWave and Sub-THz Systems,” in IEEE Journal on Selected Areas in Communications, vol. 39, no. 6, pp. 1711-1724 June 2021, doi: 10.1109/JSAC.2021.3071791. This paper describes discontinuous reception (DRX), wherein a user equipment (UE) temporarily disables its receiver, is a critical power saving feature in modern cellular systems. DRX is likely to be aggressively used at mmWave and sub-THz frequencies due to the high front-end power consumption. A key challenge for DRX at these frequencies is blockage-induced link outages: a UE will likely need to track many directional links to ensure reliable multi-connectivity, thereby increasing the power consumption. In this paper, a bandit algorithms for link tracking in connected mode DRX that reduce power consumption by tracking only a fraction of the available links, but without adversely affecting the outage and throughput performance.

C. Zhong, T. Yang, L. Zhang and J. Wang, “A New Discontinuous Reception (DRX) Scheme for LTE-Advanced Carrier Aggregation Systems with Multiple Services,” 2011 IEEE Vehicular Technology Conference (VTC Fall), 2011, pp. 1-5, doi: 10.1109/VETECF.2011.6092991. In this paper, a DRX scheme for LTE-A systems with multiple services, where some important parameters are further optimized according to the characteristics of multi-CC and multi-service systems is proposed. Simulation results demonstrate that the proposed DRX scheme can improve the energy saving efficiency significantly compared with the existing no-DRX scheme and the conventional UE-specific DRX scheme, even with 10% retransmission probability.

In order to achieve higher bandwidth and higher throughput, the carrier aggregation (CA) technique has been adopted by the specifications of 3GPP Release 10 for Long Term Evolution (LTE) advanced systems, where the user equipment (UE) may operate over up to 5 component carriers (CCs). On the other hand, 3GPP specifications also define a mechanism named discontinuous reception (DRX) in order to save the energy consumption of UE operation, where a UE is allowed to stop monitoring Physical Downlink Control Channel (PDCCH) during some period of the operation time and sidlelink control information (SCI) and Physical Sidelink Control Channel (PSCCH). Obviously, the duration and the frequency of these non-monitoring periods are important parameters which significantly impact the energy saving (ES) efficiency and the system performance. The conventional UE-specific DRX scheme is not efficient since all CCs are applied with the same DRX operation. Moreover, multiple services with different delay requirements may operate simultaneously for the same UE in the realistic communication systems. Hence, the mechanism of applying identical DRX configuration over all CCs is not optimal and will cause large energy waste.

The inspection of previous art shows that the notion of multiple-DRX is well-known. The applicability to CA, Dual Connetivitity DC, or BWP has been also recognized but, no concept explores inter-DRX assistance to dynamically provide, at least, wake-up or go-to-sleep.

With a common DRX pattern is not possible to flexibly use go-to-sleep or wake-up signals even under the assumption that some slot mapping exists between different numerologies (Note: DRX cycles are specified in terms of slot-numbers).

### BRIEF SUMMARY

The inventive approach is the solution of that problem of how to provide further enhancements for sidelink DRX applicable to CA-, DC-, or multiple-BWP-capable UE.

The problem is solved by the features given in the claims. Generally spoken the inventive approach is an intra-UE Inter-DRX coordination/assistance, which uses an indication for multiple DRX configurations per MAC entity.

### BRIEF DESCRIPTION OF THE DRAWINGS

FIG. 1 illustrates; DRX operation. ON: the RX is listening (it can receive); OFF: the RX is in sleep mode (it cannot receive).

FIG. 2 illustrates Go-to-Sleep and Wake-Up.

FIG. 3 illustrates DRX cycles for different UEs.

FIG. 4 illustrates DRX cycles or different UE.

FIG. 5 illustrates more than one DRX cycle per MAC entity.

FIG. 6 illustrates more than one DRX cycle per MAC entity and frequency ranges.

FIG. 7 illustrates Different DRX cycles for different BWPs or CCs.

FIG. 8 illustrates Different DRX cycles, where indication received via one CC and/or BWP changes the DRX cycle in another CC and/or BWP.

FIG. 9 illustrates indication options for the specific DRX (control) command

FIG. 10 illustrates the example of MAC CE and SCI @ PSSCH.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The technical solutions in the embodiments of the present application will be described below in conjunction with the drawings in the embodiments of the present application. Obviously, the described embodiments are part of the embodiments of the present application, but not all the embodiments. Based on the embodiments in the present application, all other embodiments obtained by those of ordinary skill in the art without creative work fall within the protection scope of the present application.

The technical solutions of the embodiments of the present disclosure can be applied to various communication systems, such as a Global System of Mobile Communication (GSM) system, a Code Division Multiple Access (CDMA) system, a Wideband Code Division Multiple Access (WCDMA) system, a General Packet Radio Service (GPRS), a Long Term Evolution (LTE) system, a LTE Frequency Division Duplex (FDD) system, a LTE Time Division Duplex (TDD) system, an Advanced long term evolution (LTE-A) system, a New Radio (NR) system, an evolution system of a NR system, a LTE-based access to unlicensed spectrum (LTE-U) system, a NR-based access to unlicensed spectrum (NR-U) system, an Universal Mobile Telecommunication System (UMTS), a Global Interoperability for Microwave Access (WiMAX) communication system, Wireless Local Area Networks (WLAN), Wireless Fidelity (Wi-Fi), next-generation communication systems, other communication systems, or the like.

Generally speaking, traditional communication systems support a limited number of connections and are easy to implement. However, with the development of communication technologies, mobile communication systems will not only support traditional communications, but will also support, for example, Device to Device (D2D) communication, machine to machine (M2M) communication, machine type communication (MTC), vehicle to vehicle (V2V) communication, etc. The embodiments of the present application can also be applied to these communication systems and used in automotive applications.

Optionally, the communication system in the embodiments of the present application can be applied to a Carrier Aggregation (CA) scenario, a Dual Connectivity (DC) scenario, or a Standalone (SA) deployment scenario.

Generally spoken, an embodiment of the present application is applied in a communication system. The wireless communication system can include a network device. The network device can be a device that communicates with a terminal device. The network device can provide communication coverage for a specific geographic area, and can communicate with terminal devices located in the coverage area. Optionally, the network device may be a Base Transceiver Station (BTS) in a GSM system or a CDMA system, a NodeB (NB) in a WCDMA system, an Evolutional Node B (eNB or eNodeB), a network side device or base station (gNB) in a NR system, or a wireless controller in a Cloud Radio Access Network (CRAN), or the network device can be a relay station, an access point, an in-vehicle device, a wearable device, a network-side device in a next-generation network, a network device in the future evolutional Public Land Mobile Network (PLMN), or the like.

The wireless communication system also includes at least one terminal device located within the coverage area of the network device. As used herein, “terminal device” includes, but is not limited to, a device which communicates via a wired line connection, such as a public switched telephone networks (PSTN), a digital subscriber line (DSL), a digital cable, and a direct cable connection; via another data connection/network; and/or via a wireless interface, such as those for a cellular network, a wireless local area network (WLAN), a digital TV network such as a DVB-H network, a satellite network or an AM-FM broadcast transmitter; a device of another terminal device that is configured to receive/send communication signals; and/or an Internet of Things (IoT) device. The terminal device which is configured to communicate through a wireless interface may be referred to as a “wireless communication terminal”, a “wireless terminal” or a “mobile terminal”.

The terminal device may be mobile or fixed. Optionally, the terminal device may refer to an access terminal, User Equipment (UE), a user unit, a user station, a mobile station, a moving station, a remote station, a remote terminal, a mobile device, a user terminal, a terminal, a wireless communication device, a user agent or a user device. The access terminal can be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modem, an on-board device, a wearable device, a terminal device in the future 5G network, a terminal device in a future evolutional PLMN, or the like. Optionally, Device to Device (D2D) communication may also be performed between the terminal devices.

Specifically, the network device can provide services for a cell, and the terminal device communicates with the network device through transmission resources (for example, frequency domain resources, or spectrum resources) used by the cell. The cell may be a cell corresponding to the network device (e.g., a cell corresponding to the base station), or belong to a macro base station or a base station corresponding to a small cell. The small cell herein can include a Metro cell, a Micro cell, a Pico cell, a Femto cell, etc., which are characterized in small coverage and low transmission power and are suitable for providing high-rate data transmission services.

Optionally, the wireless communication system may include multiple network devices, and other numbers of terminal devices may be included in the coverage of each of the network devices, which are not limited in the embodiments of the present application. Optionally, the wireless communication system may also include other network entities such as a network controller and a mobility management entity, which are not limited in the embodiments of the present application.

Additional Uu interface uses uplink and downlink to implement vehicle-to-vehicle communication, while PC5 (direct communication) interface uses a similar method that of DSRC which enables direct connection among vehicles.

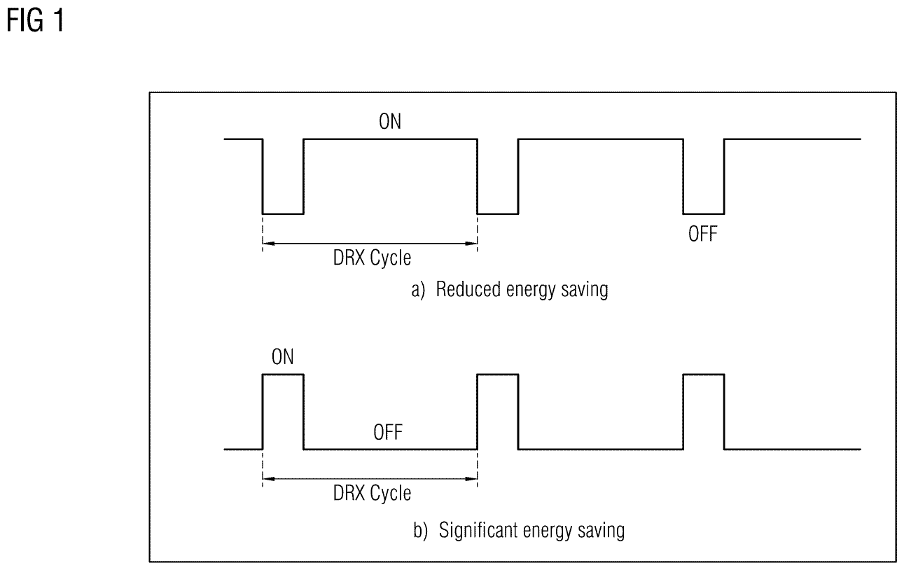

FIG. 1 illustrates; DRX operation. ON: the RX is listening (it can receive); OFF: the RX is in sleep mode (it cannot receive).

A Media Access Control (MAC) entity (MAC entity) is configured with DRX function by Radio Resource Control (RRC) to control the terminal device to monitor behaviors of Physical Downlink Control Channels (PDCCHs). For example, in a RRC CONNECTED mode, if the terminal device is configured with the DRX function, the MAC entity can continuously monitor the PDCCH during the wake-up period (On Duration), and does not monitor the PDCCH during the sleep period (Opportunity for DRX), thereby reducing the power consumption of the terminal device. The network device can configure a set of DRX parameters for the MAC entity through RRC signaling to manage the wake-up and sleep states of the terminal device. A DRX cycle can be obtained according to values of these parameters, as shown in FIG. 1.

The BWP is introduced in NR. The terminal device in the connected state can support up to 4 downlink BWPs and up to 4 uplink BWPs. At the same time, the terminal device uses at most one BWP at a time. The terminal device can switch between the BWPs. For example, the network device can dynamically control the terminal device to switch the downlink BWP or the uplink BWP by sending Download Control Information (DCI), so as to achieve scheduling flexibility and save power consumption. In addition, for the downlink BWP, the control resource set (CORESET) and search space can be configured for the BWP dedicated to each terminal device, so that the terminal device can detect the physical downlink control channel (PDCCH) on the BWP.

Currently, the DRX parameters are configured for each MAC entity, that is, the DRX parameters apply to the CORESETs and search spaces configured on all BWPs. In a DRX cycle, if the terminal device is in the DRX active time, it needs to blindly detect all possible PDCCH transmission positions on the currently activated downlink BWP, and if the PDCCH is detected on any possible PDCCH transmission position and the PDCCH schedules a new uplink or downlink data transmission, a drx-InactivityTimer will be reset.

It can be seen that since the configuration of DRX parameters is not flexible enough, it is difficult to meet service level requirements on different BWPs. For example, for one BWP, the network device may expect the BWP to be used for scheduling delay-sensitive services, and the network device may configure a relative short cycle for the search space on this BWP. For another BWP, the network device may expect the BWP to be used for scheduling services with high rate requirements, and the network device may configure a relatively long cycle for the search space on this BWP. The DRX parameters are configured for each MAC entity. Therefore, even if the BWP of the terminal device is switched, the DRX parameters cannot meet the service transmission requirements on the BWP. Especially the aspect of inter-DRX coordination and assistance to dynamically provide, at least, wake-up or go-to-sleep is not known.

Data transmission between UEs and their base stations (eNodeB, gNB) uses radio frames with 10 ms duration, where in each radio frame consists of 10 1 ms (1 frame=10 ms duration=10 subframe) subframes. Physical Downlink Control Channel (PDCCH) at the beginning of each subframe indicates whether there is data for UE to receive or not. Devices has to monitor these PDCCHs in each subframe so that it can find out whether they carry any data to receive. Because devices do not receive data in every subframe, this monitoring process naturally leads to high battery consumption, like it is shown in FIG. 1.

The main purpose of DRX is to lower power consumption when there is no UL/DL data. That means, when there is no data traffic (DL/UL) that time devices enter into sleep mode (with RF module turned off) for some period of time as configured by network device. When sleep timer expired or there is traffic, the UEs wake up for data reception/transmission.

The network delivers this information to UE through upper layer control message, RRC reconfiguration message (during handover) or System Information Block Type 2 (SIB2) broadcasted by network device (during initial attach).

There are two types of DRX process that can be used in either RRC-Idle or RRC-Connected state. When DRX is used in Idle state, it is called Idle mode DRX and when in Connected state, it is called Connected mode DRX (C-DRX).

Idle mode DRX: it is used for Paging DRX cycle.

Connected mode DRX (C-DRX): There are two types in connected mode-Short DRX cycle, Long DRX cycle.

When the UE is in RRC Connected state, it keeps monitoring PDCCH. During this period if any DL Grant or downlink data for that UE is received, then that time DRX inactivity timer and the main RRC inactivity timer are restarted.

If there is UL grant for UE with DL Grant that time both DRX and RRC inactivity timers are restarted and after 4 ms UE sends data in uplink. The DRX inactivity timer expires when there are no further grants for uplink or downlink. Although UE was constantly monitoring PDCCH, UE now enters in the short DRX cycle. If operator has only configured long DRX, then UE directly enters in Long DRX, but in the above example both are configured. The current energy consumption drops and battery power is conserved. When the DRX short cycle timer expires, UE end up short DRX cycle and goes into the long DRX cycle.

When there is no activity in UL or DL for the duration of RRC inactivity timer, the timer expires, and the UE enters into RRC IDLE state. In this state, UE uses paging DRX cycle.

The UE would be transmitting frequent periodic CSI or SRS, if configured by network device without DRX.

With DRX, during OFF periods, the UE is not allowed to transmit periodic CSI or SRS, so to maximize resource utilization, the network device can assign these resources to the other UEs.

DRX is controlled by RRC by configuring the following timers:
1. onDuration Timer
2. drx-InactivityTimer
3. drx-Retransmission Timer (one per DL HARQ process except for the broadcast process),
4. drx-ULRetransmissionTimer (one per asynchronous UL HARQ process)
5. the longDRX-Cycle
6. drxStartOffset
7. drxShortCycleTimer (optional)
8. shortDRX-Cycle (optional)

Wherein, each DRX configuration may include, for example, at least one of the following parameters:
onDuration Timer: the number of consecutive PDCCH-subframes to monitor at the beginning of each DRX Cycle (DRX ON). Range: PDCCH subframe 1 to PDCCH subframe 200.
drx-InactivityTimer: The number of consecutive PDCCH subframe(s) to monitor after successfully decoding a PDCCH indicating scheduling info. Range: PDCCH subframe 1 to PDCCH subframe 2560.
drx-RetransmissionTimer: The maximum number of consecutive PDCCH-subframe(s) till a DL retransmission is received.
Its Range: PDCCH subframe 1 to PDCCH subframe 33.
drxstartoffset: the subframe where the DRX cycle starts.
drxShortCycleTimer: number of time short DRX cycle is repeated. Range (1 to 16).
shortDRX-cycle: the drx cycle running only within drxshortcycletimer period at the expiration of DRX-inactivity timer.

Network informs UE of this timing using RRC Connection Reconfiguration or RRC Connection Setup msg.
drx-Config: setup (1)
setup
onDuration Timer: psf7 (5)
drx-InactivityTimer: psf1900 (20)
drx-Retransmission Timer: psf20 (5)
longDRX-CycleStartOffset: sf1280 (13)
sf1280: 0
shortDRX
shortDRX-Cycle: sf7 (3)
drxShortCycleTimer: 9 shortDRX-Cycles

Illustration of DRX operation. ON: the RX is listening, means it can receive; OFF: the RX is in sleep mode, means it cannot receive.

Discontinuous Reception (DRX) is a power saving mechanism, by allowing UE to enter sleep mode at regular period by turning off its RF modem, baseband receiver etc, in which ON and OFF periods are defined mainly at reception side.

DRX operation also affects potential transmitters, or at least, it should be considered for sake of efficient operation. DRX has also been introduced for sidelink (PC5).

DRX configuration is known by TX and RX (i.e., is pre-configured). Network devices are able to configure long DRX only and long DRX along with short DRX.

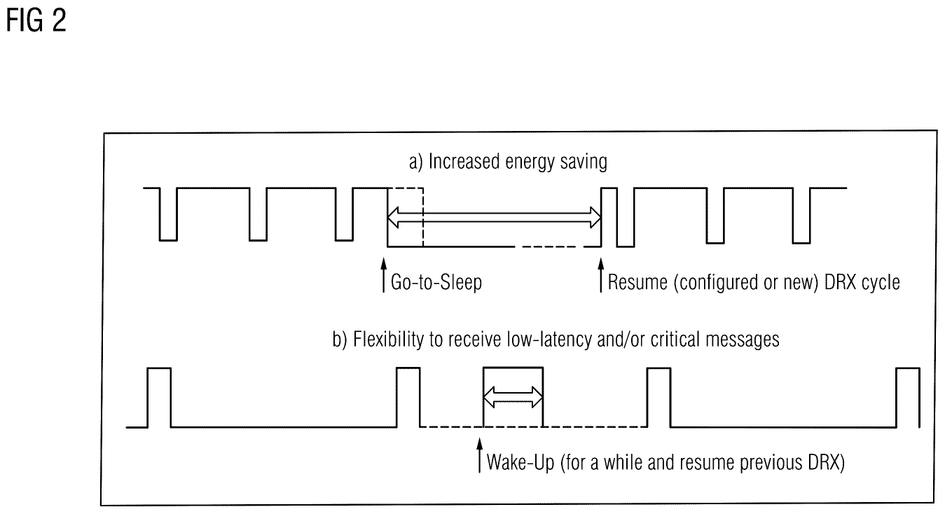

FIG. 2 illustrates Go-to-Sleep and Wake-Up and it shows the background, the context and relevance. Go-to-Sleep and Wake-Up messages can also be used in sidelink to allow increased energy saving and/or to make the operation more agile. Evidently Go-to-Sleep and Wake-Up messages can only be received during ON periods or using special channels.

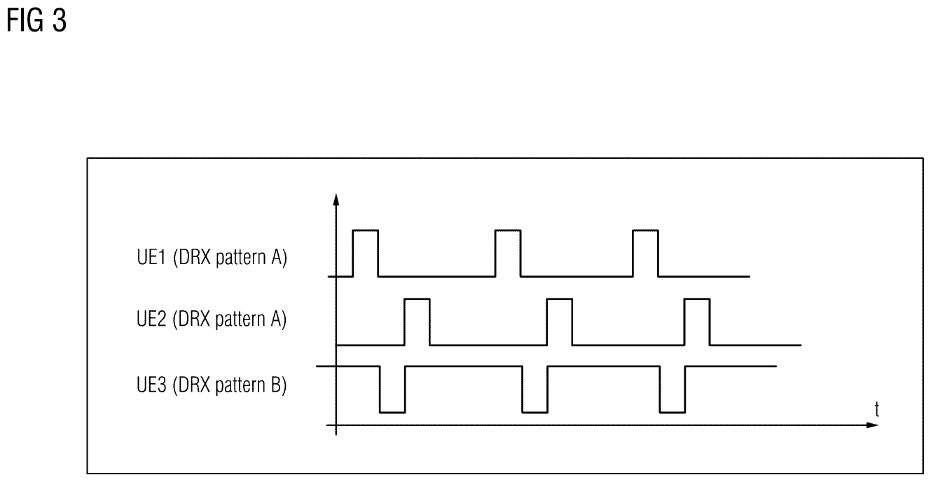

FIG. 3 illustrates DRX cycles for different UEs, this means DRX cycles for different UEs can be different and not synchronized. DRX cycles (patterns) can be different and are not necessarily aligned. Resource selection/allocation/scheduling must consider this. In current specification only one DRX cycle can be configured per MAC entity, although this unique DRX configuration can be modified.

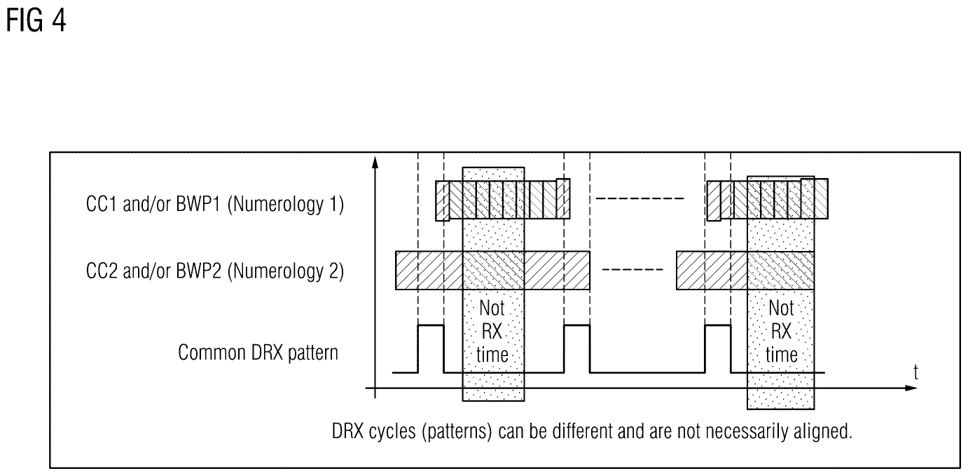

FIG. 4 illustrates DRX cycles or different UE and describes the motivation. DRX cycles or different UE and base stations (gNB) can be different and not synchronized. DRX cycles (patterns) can be different and are not necessarily aligned. With a common DRX pattern is not possible to flexibly use go-to-sleep or wake-up signals even under the assumption that some slot mapping exists between different numerologies. It has to be mentioned, that DRX cycles are specified in terms of slot numbers), thereby CC means Component Carrier and BWP means Bandwidth Part.

FIG. 5 illustrates that more than one DRX cycle per MAC entity can be used. Enable more than one DRX cycle per MAC entity which can be directly applied to both BWPs within same CC and CCs, either within same band or in different bands. Currently, only one bandwidth part can be active in sidelink, but this can be modified making this invention also relevant for sidelink BWPs.

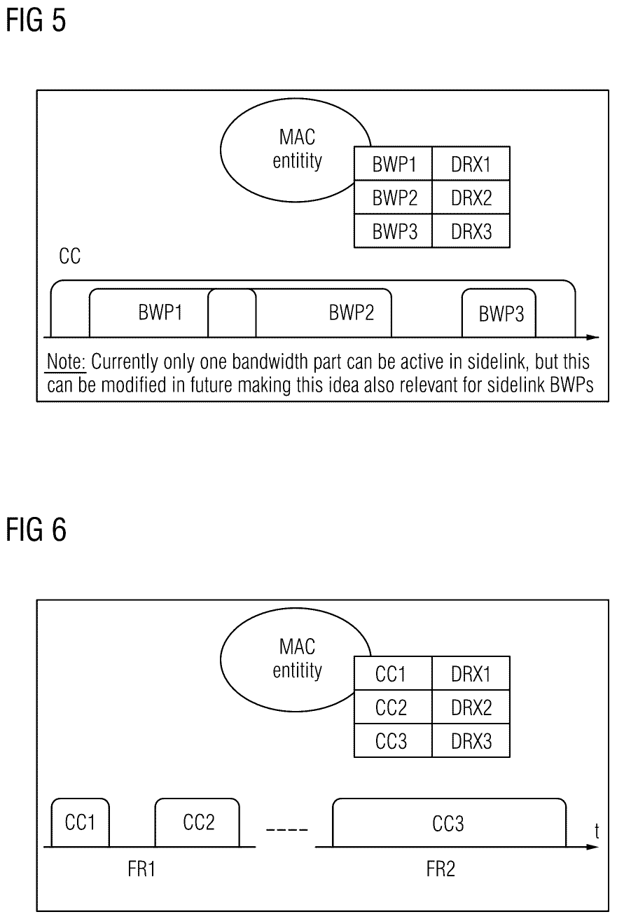

FIG. 6 illustrates more than one DRX cycle per MAC entity and frequency ranges.

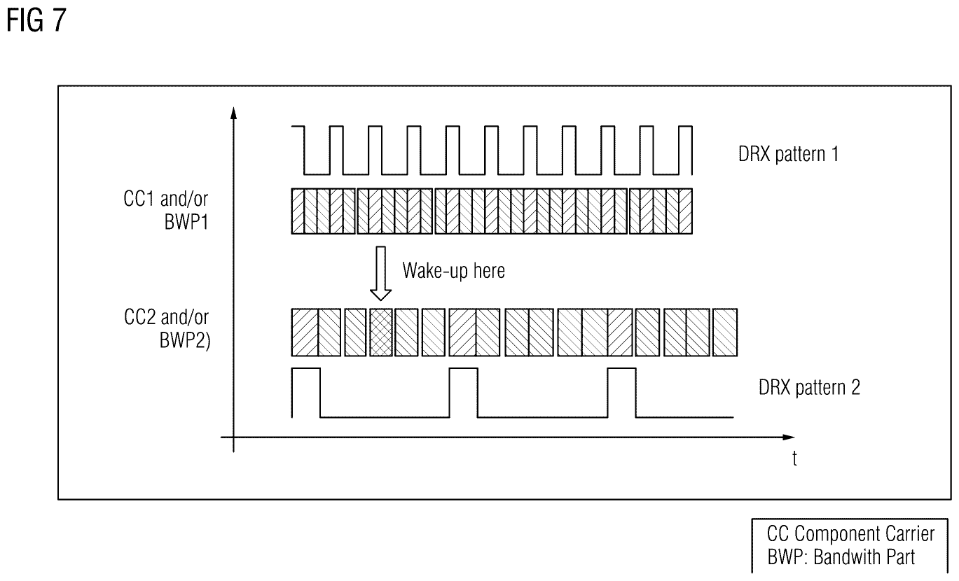

FIG. 7 illustrates Different DRX cycles for different BWPs or CCs transmitter as an example 1 for Inter-DRX assistance for the wake up activation. Different DRX cycles for different BWPs or CCs transmitter is aware of.

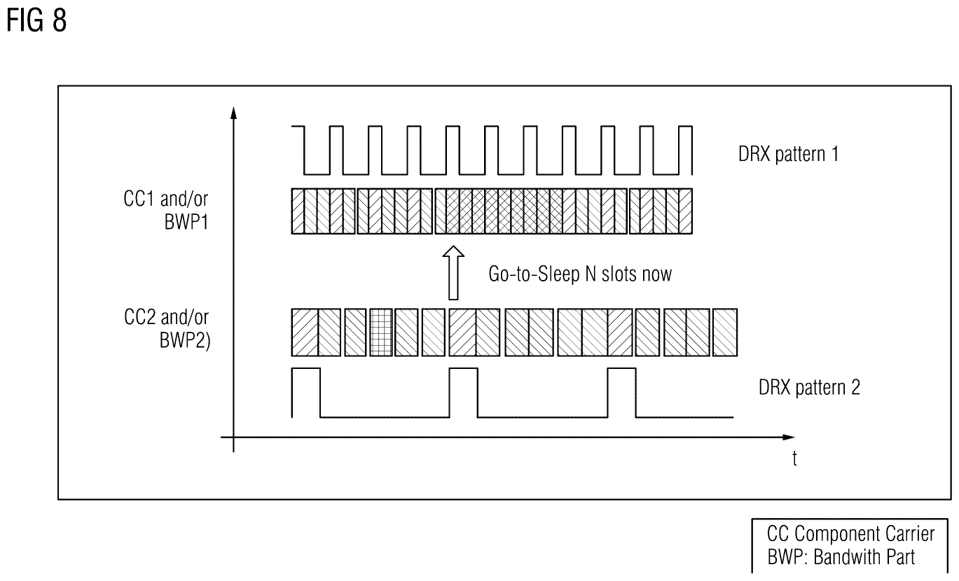

FIG. 8 illustrates Different DRX cycles as an example 2 for Inter-DRX assistance for the go-to-sleep activation, where indication received via one CC and/or BWP changes the DRX cycle in another CC and/or BWP.

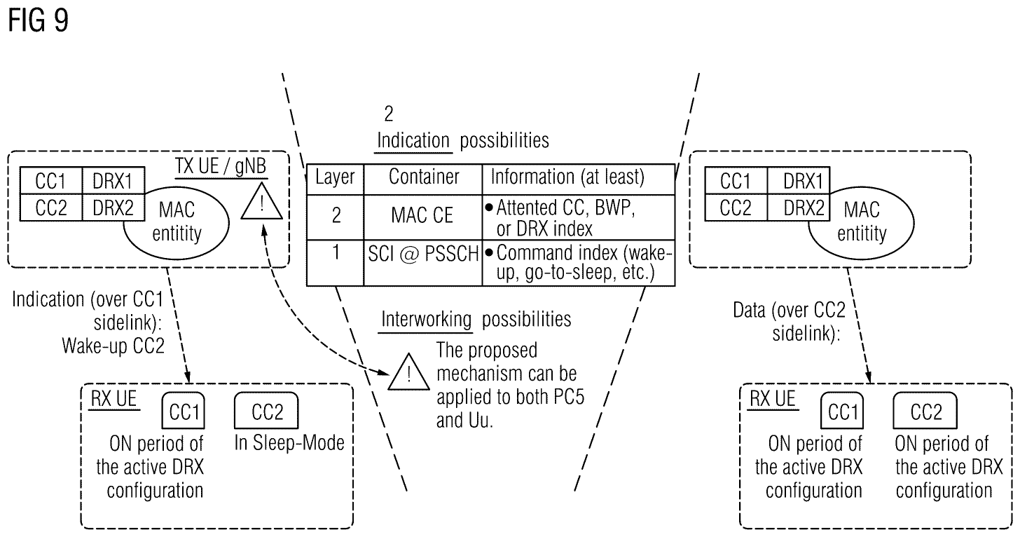

FIG. 9 illustrates indication options for the specific DRX (control) command.

The MAC entity of the transmitter part of an UE or the transmitter part of a base station (gNB) is indicating over CC1 sidelink a wake-up of CC1 by the indication possibilities via SCI@PSSCH or MAC CE. The indicated information of this transmission affects CC, BWP, or DRX index and command index like wake up, go-to-sleep, etc.

On the receiver UE CC1 activated on period of active DRX configuration. The proposed mechanism can be applied to both PC5 and Uu. The indication, which is over CC1 sidelink is a control channel activation. If CC2 has changed its mode from sleep to on/awake through the indication over CC1 sidelink the transmitter UE activates a data transmission over CC2 to the receiver UE on period of active DRX configuration of CC2. Relevant here is the indication of specific commands and the indication options for the specific DRX (control) command, like it is shown in FIG. 9.

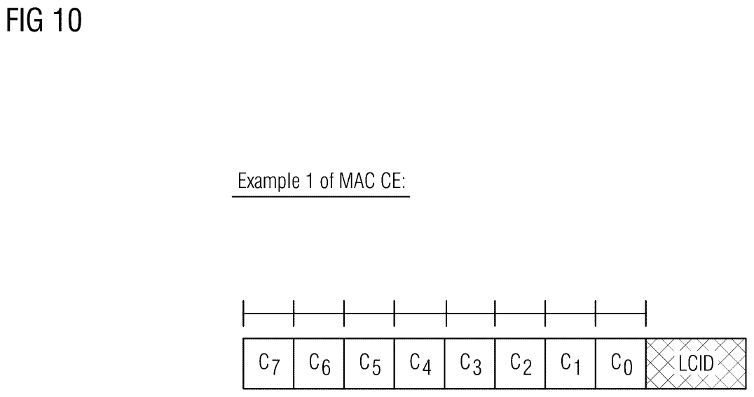

FIG. 10 illustrates the example of MAC CE and SCI @ PSSCH.

The Example 1 of MAC CE: The Cᵢ field is set to 1 to indicate that go to sleep shall be activated. The Cᵢ field is set to 0 to indicate that go to sleep shall be deactivated.

Example 2 of MAC CE: The Cᵢ field is set to 1 to indicate that data transmission shall be activated. The Cᵢ field is set to 0 to indicate that data transmission shall be deactivated.

### Example of SCI PSSCH

SCI DCI carried the information regarding carrier indicator and go to sleep. For example, if 4 bit can indicate up to 16 carrier information. 1 bit is used to indicates that go to sleep is activated or not ((1 indicates activated and 0 indicates deactivated)).

For example, if gNB want to set carrier 0 activated then it will set 0000 and 1 in SCI DCI.

This invention is inherently relevant for mmW and/or FR2, as it is compatible and will benefit with FR1+FR2 aggregation and bandwidth parts, where currently one DRX is supported. Support for multiple DRX per MAC entity is essential. The invention applies for both Uu and PC5 and it can be applied in a very general manner to cover any interface with more than one CC, BWP, and corresponding DRX cycles. Most relevant are the beneficial aspect of power saving, flexible resource allocation as well as transmit and/or receive mode switching.

1. An inter-DRX Assistance method for operating a user equipment (UE) and a base station (gNB), of a wireless communication system in a Discontinuous Reception (DRX) mode, the wireless communication system including a plurality of user equipments (UEs) and base stations (gNBs), and the UE and/or base stations (gNBs) communicating with one or more further user equipments (UEs) and base stations (gNBs) using the method comprising:
receiving, by the user equipment (UE), a least one Discontinuous Reception (DRX) configuration from one of a plurality of a Discontinuous Reception (DRX) configuration sources,
characterized by
that a plurality of Discontinuous Reception (DRX) configurations is configured for the same Medium Access Control (MAC) entity in order to reduce an energy consumption of the user equipments.

2. The method according to claim 1,
wherein more than one Discontinuous Reception (DRX) configurations are configured for the same Medium Access Control (MAC) entity in order to provide a flexible resource allocation.

3. The method according to claim 1,
wherein that more than one Discontinuous Reception (DRX) configurations is configured per bandwidth part (BWP) or component carrier (CC) or both.

4. The method according to claim 1,
wherein a first Discontinuous Reception (DRX) configuration is configured for a lower frequency band (FR1) and a second Discontinuous Reception (DRX) configuration is configured for a higher frequency band (FR2).

5. The method according to claim 1,
wherein a first Discontinuous Reception (DRX) configuration is configured for a lower frequency band 1 (FR1) and a second Discontinuous Reception (DRX) configuration is configured for a higher frequency band 2 (FR2), whereby component carrier 1 (CC1) and component carrier 2 (CC2) can be operated either through frequency band 1 (FR1) or frequency band 2 (FR2)

6. The method according to claim 1
wherein if one the component carrier (CC1, CC2) is turned off, it can awake up through the other component carrier (CC1, CC2), which is on.

7. The method according to claim 1,
characterized by
that transmitter part of the user equipment (TX UE) or the base station (gNB) is activating over component carrier 1 (CC1) via an indication in order to change the status of component carrier 2 (CC2) from sleep to on.

8. The method according to claim 1,
characterized by
that transmitter part of the user equipment (TX UE) is activating over component carrier 1 (CC1) via an indication in order to change the status of component carrier 2 (CC2) from on to sleep.

9. The method according to claim 1,
characterized by
that indication is done via Medium Access Control (MAC) Control Element (CE) signaling.

10. The method according to claim 1,
wherein, in the MAC Control Element, “1” indicates the status of component carrier being on and “0” indicates the status of component carrier (CC1, CC2) being off.

11. The method according to claim 1, characterized by
that indication is done by Sidelink Control Information (SCI), Physical Sidelink Shared Channel (PSSCH) and/or Physical Sidelink Control Channel (PSCCH).

12. The method according to claim 1,
wherein, in the sidelink control information (SCI) Physical Sidelink Control Channel (PSCCH), indicates component carrier being on.

13. The method according to claim 1,
wherein, in the sidelink control information (SCI) Physical Sidelink Control Channel (PSCCH), indicates component carrier being off.

14. The method according to claim 1,
wherein user equipment (UE) is a sidelink UE (SL).

15. The method according to claim 1,
wherein the bitmap has a fixed size of one or more octets.

16. The method according to claim 1, UE, of a wireless communication system, the wireless communication system including a plurality of user equipments, UEs, and the UE communicating with one or more further UEs using a sidelink, SL, the method comprising:
operating the UE in a Discontinuous Reception, DRX, mode in accordance with a DRX configuration including one or more DRX patterns defining a fixed length DRX cycle or an adaptive length DRX cycle for a time period the DRX configuration is valid,
wherein, in case of a fixed length DRX cycle, an overall duration of a DRX cycle and the ON-OFF durations of the DRX cycle are fixed, and, in case of an adaptive length DRX cycle, an overall duration of a DRX cycle and/or the ON-OFF durations of the DRX cycle is adapted dependent on one or more parameters, e.g., parameters associated with the UE and/or the environment in which the UE is located.

17. The method according to claim 1 within a wireless communication system in a Discontinuous Reception, DRX, mode, the wireless communication system including a plurality of user equipments, UEs, and the UE communicating with one or more further UEs using a sidelink, SL, the method further comprising:
aligning, by the UE, the DRX cycles of the UE with an access point, like a base station, gNB, or a gateway node, of the wireless communication system and/or one or more of the further UEs.

18. The method according to claim 1 within a wireless communication system in a Discontinuous Reception, DRX, mode, the wireless communication system including a plurality of user equipments, UEs, and the UE communicating with one or more further UEs using a sidelink, SL, the method comprising: setting, by the UE, an ON duration of a DRX cycle dependent on a certain purpose for which the UE is to use the ON duration.

19. The method according to claim 1 within wireless communication system in a Discontinuous Reception, DRX, mode, the wireless communication system including a plurality of user equipments, UEs, and the UE communicating with one or more further UEs using a sidelink, SL, the method comprising: receiving, by the UE, one or more DRX configurations from a DRX synchronization source, wherein
when the DRX synchronization source includes a base station, receiving, by the UE, from the base station a control message, SIB, including the one or more DRX configurations, or
when the DRX synchronization source includes one or more of the further UEs, receiving, by the UE, the one or more DRX configurations from a further UE using, a PC5 RRC signaling or a SCI for a given transmission.

20. The method according to claim 1 within wireless communication system, the wireless communication system including a plurality of user equipments, UEs, and the UE communicating with one or more further UEs using a sidelink, SL, not operating in a Discontinuous Reception, DRX, mode but being aware of one or more of the further UEs operating in the DRX mode, the method comprising:
avoiding, by the UE, resources for a transmission that are used by a further UE during its ON duration.

21. (canceled)

22. An apparatus comprising a processor, a memory, and communication circuitry, the apparatus being connected to a network via its communication circuitry, the apparatus further comprising computer-executable instructions stored in the memory of the apparatus which, when executed by the processor of the apparatus, cause the apparatus to perform operations comprising:
receiving a configuration signal; and
based on the configuration signal, determining a processor interrupt time unit to be used for timing of a medium access control (MAC) procedure,
wherein the processor interrupt time unit is based on at least one of:
a capability of the apparatus, a minimum slot duration associated with the apparatus, or a minimum slot duration associated with a numerology
wherein,
the apparatus is configured for operating a user equipment (UE) and a base station (gNB), of a wireless communication system in a Discontinuous Reception (DRX) mode, the wireless com tion system including a plurality of user equipments (UEs) and base stations (gNBs), and the UE and/or base stations (gNBs) communicating with one or more further user equipments (UEs) and base stations (gNBs) by performing operations comprising:
receiving, by the user equipment (UE), a least one Discontinuous Reception (DRX) configuration from one of a plurality of a Discontinuous Reception (DRX) configuration sources,
characterized by
that a plurality of Discontinuous Reception (DRX) configurations is configured for the same Medium Access Control (MAC) entity in order to reduce an energy consumption of the user equipments.
